(19) United States
(12) Patent Application Publication
(10) Pub. No.: US 2026/0319415 A1
(43) Pub. Date: Oct. 15, 2026

(54) IMAGE FORMING APPARATUSES

(71) Applicant: CANON KABUSHIKI KAISHA, Tokyo (JP)

(72) Inventor: KAZUHISA KOIZUMI, Chiba (JP)

(21) Appl. No.: 19/467,542

(22) Filed: Feb. 2, 2026

(30) Foreign Application Priority Data
Feb. 5, 2025 (JP) 2025-017427

(51) Int. Cl. G03G 15/00; B41J 11/00

(52) U.S. Cl. CPC G03G 15/5062; B41J 11/008; B41J 11/0095; G03G 15/5029

(57) ABSTRACT

Image forming apparatuses are provided herein. At least one image forming apparatus includes a first light emitting portion, a second light emitting portion, a light receiving portion disposed to face the first surface of the sheet conveyed in the conveyance path, the light receiving portion being configured to receive first light that is emitted from the first light emitting portion and is reflected by the first surface, and second light that is emitted from the second light emitting portion and is passed through the conveyance path, and processor(s) configured to: (i) detect a position of a side edge portion of the sheet in a sheet width direction intersecting the sheet conveyance direction based on the light receiving portion receiving the second light, and (ii) detect a position of a predetermined image previously formed on the first surface of the sheet based on the light receiving portion receiving the first light.

### BACKGROUND

### Field of the Technology

The present disclosure relates to one or more embodiments of an image forming apparatus that forms an image on a sheet and to one or more embodiments of an inkjet recording apparatus.

### Description of the Related Art

In recent years, a demand for digital printing capable of printing small-lot, multi-variety designs is increased in the fields of commercial and industrial printing. The digital printing is suitable for applications for printing variable user data, such as address information, onto pre-printed sheets, such as invoices, on which pre-printed images such as formatted table borders or the like are printed. In a case of the pre-printed sheets, image forming apparatuses are required to form user images on the pre-printed sheets in alignment with the pre-printed images.

According to Japanese Patent Laid-Open No. 2017-202916, an image forming apparatus is proposed that detects a position of a side edge in a width direction of a sheet by means of a reflection sensor constituted by a contact image sensor (CIS). The image forming apparatus includes a nip roller capable of moving in the width direction in a state of nipping the sheet, and corrects misalignment in the width direction of the sheet using this nip roller.

However, the image forming apparatus described in Japanese Patent Laid-Open No. 2017-202916 can detect the position of the side edge of the sheet, but cannot detect the pre-printed images of the pre-printed sheets. Therefore, a relative position between the pre-printed image and a user image, which is additionally formed on the pre-printed sheet, fluctuates.

### SUMMARY

In one or more aspects of the present disclosure, one or more embodiments may suppress fluctuation by detecting not only the position of the sheet but also the position of the pre-printed image.

According to one or more aspects of the present disclosure, at least one embodiment of an image forming apparatus may include a first light emitting portion disposed to face a first surface of a sheet conveyed in a conveyance path in a sheet conveyance direction, the first light emitting portion being configured to emit light toward the first surface, a second light emitting portion disposed to face a second surface opposite to the first surface of the sheet conveyed in the conveyance path, the second light emitting portion being configured to emit light toward the second surface, a light receiving portion disposed to face the first surface of the sheet conveyed in the conveyance path, the light receiving portion being configured to receive a first light that is emitted from the first light emitting portion and is reflected by the first surface, and to receive a second light that is emitted from the second light emitting portion and is passed through the conveyance path, and one or more processors that operate to: (i) detect a position of a side edge portion of the sheet in a sheet width direction intersecting the sheet conveyance direction based on the light receiving portion receiving the second light, and (ii) detect a position of a predetermined image previously formed on the first surface of the sheet based on the light receiving portion receiving the first light.

According to one or more aspects of the present disclosure, at least one embodiment of an image forming apparatus may include a first light emitting portion disposed to face a first surface of a sheet conveyed in a conveyance path in a sheet conveyance direction, the first light emitting portion being configured to emit light toward the first surface, a second light emitting portion disposed to face a second surface opposite to the first surface of the sheet conveyed in the conveyance path, the second light emitting portion being configured to emit light toward the second surface, a light receiving portion disposed to face the first surface of the sheet conveyed in the conveyance path, the light receiving portion being configured to receive a first light that is emitted from the first light emitting portion and is reflected by the first surface, and to receive a second light that is emitted from the second light emitting portion and is passed through the conveyance path, a shifter disposed downstream of the first light emitting portion, the second light emitting portion, and the light receiving portion in the sheet conveyance direction, the shifter being configured to move the sheet in a sheet width direction intersecting the sheet conveyance direction, and one or more processors that operate to control the shifter based on a detection result of the first light received by the light receiving portion and a detection result of the second light received by the light receiving portion.

According to other aspects of the present disclosure, one or more additional image forming apparatuses and one or more inkjet recording apparatuses are discussed herein. Features of the present disclosure will become apparent from the following description of embodiments with reference to the attached drawings. The following description of embodiments is described by way of example.

### BRIEF DESCRIPTION OF THE DRAWINGS

FIG. 1 is an overall schematic diagram illustrating at least one embodiment of an image forming apparatus according to one or more aspects of the present disclosure.

FIG. 2 is a perspective view illustrating a laser scanning unit or laser scanner according to one or more aspects of the present disclosure.

FIG. 3A is a plan view illustrating at least one embodiment of a registration device/unit according to one or more aspects of the present disclosure.

FIG. 3B is a diagram illustrating at least one embodiment of an image sensor according to one or more aspects of the present disclosure.

FIG. 4 is a block diagram illustrating at least one embodiment of a control block of an image forming apparatus according to one or more aspects of the present disclosure.

FIG. 5 is a flowchart illustrating at least one embodiment of image position alignment control according to one or more aspects of the present disclosure.

FIG. 6 is a diagram illustrating specific examples of one or more embodiments of pre-printed images formed on a sheet according to one or more aspects of the present disclosure.

FIG. 7 is a diagram illustrating at least one embodiment of a detection of a pre-printed image in a case where a sheet which is set in a proper orientation is conveyed according to one or more aspects of the present disclosure.

FIG. 8 is a diagram illustrating at least one embodiment of a detection of a pre-printed image in a case where a sheet which is set in an incorrect orientation is conveyed according to one or more aspects of the present disclosure.

FIG. 9 is a diagram illustrating an example of at least one embodiment of a method for calculating a shift amount of a sheet according to one or more aspects of the present disclosure.

FIG. 10 is a schematic diagram illustrating an example of a schematic configuration of at least one embodiment of an inkjet recording apparatus according to one or more aspects of the present disclosure.

FIG. 11 is a block diagram illustrating at least one embodiment of a control block of an inkjet recording apparatus according to one or more aspects of the present disclosure.

### DESCRIPTION OF THE EMBODIMENTS

### One or More Embodiments

### Overall Configuration(s) of the One or More Embodiments

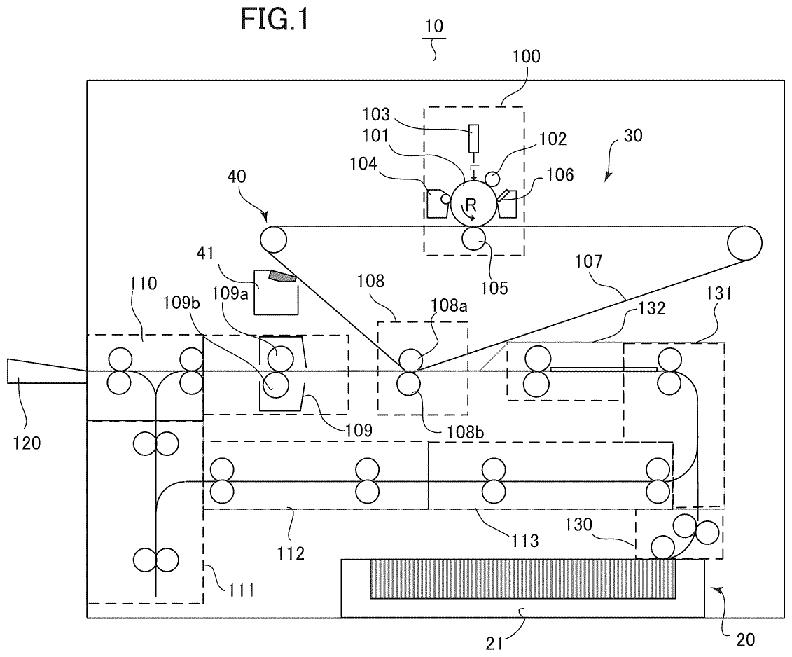

First, one or more embodiments of the present disclosure will be described. An image forming apparatus 10 is a laser beam printer of an electrophotographic system. As illustrated in FIG. 1, the image forming apparatus 10 includes a sheet feeding apparatus 20, a vertical path conveyance unit or conveyor 131, a registration device or unit 132, an image forming unit or image forming device/structure 30, a fixing unit or fixer 109, a sheet discharge conveyance unit or conveyor 110, and a sheet discharge tray 120. Further, the image forming apparatus 10 includes a reverse conveyance unit or conveyor 111, and duplex conveyance units or conveyors 112 and 113.

The image forming unit or imaging forming device 30 includes an image formation engine 100 that forms a toner image of, for example, black (K), and an intermediate transfer unit or device 40. The image formation engine 100 includes a photosensitive drum 101, serving as a photosensitive member, a charge roller 102, a laser scanning unit or scanner 103, serving as an exposing unit or device/structure, a developing unit or developer 104, serving as a developing unit or developer, a primary transfer roller 105, and a drum cleaner 106. The photosensitive drum 101 is constituted by applying an organic photoconductive layer to an outer circumferential surface of an aluminum cylinder, and is rotated in an arrow R direction by a drive motor, not shown.

The intermediate transfer unit or device 40 includes a secondary transfer inner roller 108a, a secondary transfer outer roller 108b, and an intermediate transfer belt 107, which is wound around rollers such as the secondary transfer inner roller 108a. The secondary transfer inner and outer rollers 108a and 108b form a secondary transfer portion 108 that secondarily transfers a toner image on the intermediate transfer belt 107 onto a sheet, and a nip of the secondary transfer portion 108 constitutes an image formation position at which a user image, serving as an image, is formed on the sheet S.

To be noted, in one or more embodiments, the image forming unit 30 includes only one image formation engine 100; however, it is not limited to this. For example, the image forming unit 30 may include four image formation engines that may respectively form toner images of yellow (Y), magenta (M), cyan (C), and black (K). In this case, the toner images of yellow (Y), magenta (M), cyan (C), and black (K) are overlapped on the intermediate transfer belt 107, and are collectively transferred onto the sheet at the secondary transfer portion 108. In addition, the image forming unit 30 may omit the intermediate transfer unit 40 and arrange the image formation engine on a conveyance path of the sheet. In this case, the toner image is transferred onto the sheet at a transfer nip between the photosensitive drum 101 and the primary transfer roller 105.

The fixing unit 109 includes a fixing roller 109a and a pressurizing roller 109b, and fixes the toner image on the sheet onto the sheet at a fixing nip 121 formed by the fixing and pressurizing rollers 109a and 109b.

The sheet feeding apparatus 20 includes a cassette 21 for storing the sheet and a sheet feeding unit 130 constituted by a pickup roller, a separation roller, and the like. The sheet feeding unit 130 feeds the sheet stored in the cassette 21, and conveys the sheet to the vertical path conveyance unit 131.

Next, an image formation operation of the image forming apparatus 10 which is configured as described above will be described. When an image signal (light source control data L1 to Ln, described below) is input from a personal computer or the like, not shown, to the laser scanning unit 103 of the image formation engine 100, laser light corresponding to the image signal is emitted from the laser scanning unit 103 onto the photosensitive drum 101.

At this time, the photosensitive drum 101 has been uniformly charged to a predetermined polarity and potential previously on its surface by the charge roller 102, and, when the laser light is irradiated from the laser scanning unit 103, an electrostatic latent image is formed on the surface. The electrostatic latent image formed on the photosensitive drum 101 is developed by the developing unit 104, and the toner image of, for example, black (K) is formed on the photosensitive drum 101.

The toner image formed on the photosensitive drum 101 is primarily transferred onto the intermediate transfer belt 107 by the primary transfer roller 105. Then, the toner image is conveyed to the secondary transfer portion 108 by the intermediate transfer belt 107 which rotates. Toner remaining on the photosensitive drum 101 is collected by the drum cleaner 106.

In parallel with this image formation process, the sheet is fed from the sheet feeding apparatus 20, and is conveyed to the registration device or unit 132 by the vertical path conveyance unit 131. The registration device or unit 132 conveys the sheet to the secondary transfer portion 108. The toner image on the intermediate transfer belt 107 is transferred onto a first surface (front surface) of the sheet by a secondary transfer bias applied to the secondary transfer outer roller 108b.

At the secondary transfer portion 108, a high voltage is applied, and the applied voltage is optimized for each type of the sheet. Toner remaining on the intermediate transfer belt 107 is collected by a belt cleaner 41 of the intermediate transfer unit 40.

The sheet onto which the toner image has been transferred is conveyed to the fixing unit 109. Then, the sheet is guided to the fixing nip 121 of the fixing unit 109, and predetermined heat and pressure are applied; thus, the toner is melted and bonded (fixed). The sheet that has passed through the fixing unit 109 undergoes path selection to determine whether the sheet discharge conveyance unit 110 conveys the sheet to either the sheet discharge tray 120 or the reverse conveyance unit 111. To be noted, after the sheet has been conveyed to the reverse conveyance unit 111, the sheet may be inverted such that the first surface on which the image has been formed becomes a lower side, and, then, the sheet may be conveyed to the sheet discharge tray 120.

In a case of forming the image only on one side of the sheet, the sheet is discharge to the sheet discharge tray 120 by the sheet discharge conveyance unit 110. In a case of forming the image on both sides of the sheet, the sheet is conveyed to the reverse conveyance unit 111 by the sheet discharge conveyance unit 110, and is conveyed in a switchback manner at the reverse conveyance unit 111. The sheet which has been conveyed in a switchback manner is conveyed from the reverse conveyance unit 111 to the duplex conveyance units 112 and 113, and is guided to the vertical path conveyance unit 131. Thereafter, the image is formed on a second surface (back surface) of the sheet at the secondary transfer portion 108, and is discharged to the sheet discharge tray 120.

Laser Irradiation/Scanning unit or Laser Scanner

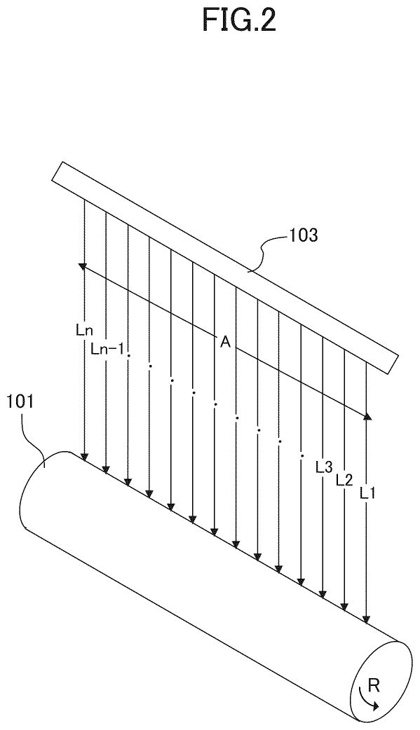

Next, using FIG. 2, a configuration of the laser scanning unit 103 will be described. FIG. 2 is a perspective view illustrating the laser scanning unit 103. The laser scanning unit 103 includes a light source capable of adjusting a light quantity for each pixel within a predetermined region A in a sheet width direction W parallel to a rotational axis direction of the photosensitive drum 101. Each pixel is defined according to the resolution of the image to be formed; for example, in a case where the resolution is 600 dots per inch (dpi), the size of one pixel becomes 25.4 micrometers (μm).

Light quantity adjustment by the laser scanning unit 103 includes the activation and deactivation of light for each individual pixel. In addition, the laser scanning unit 103 forms the electrostatic latent image on the photosensitive drum 101 by controlling the light quantity according to a predetermined emission pattern generated in advance based on user image formation data. The light quantity control described above is performed based on the light source control data L1 to Ln (where n is a predetermined natural number) for each pixel in the region A.

### Registration Device or Unit for One or More Embodiments

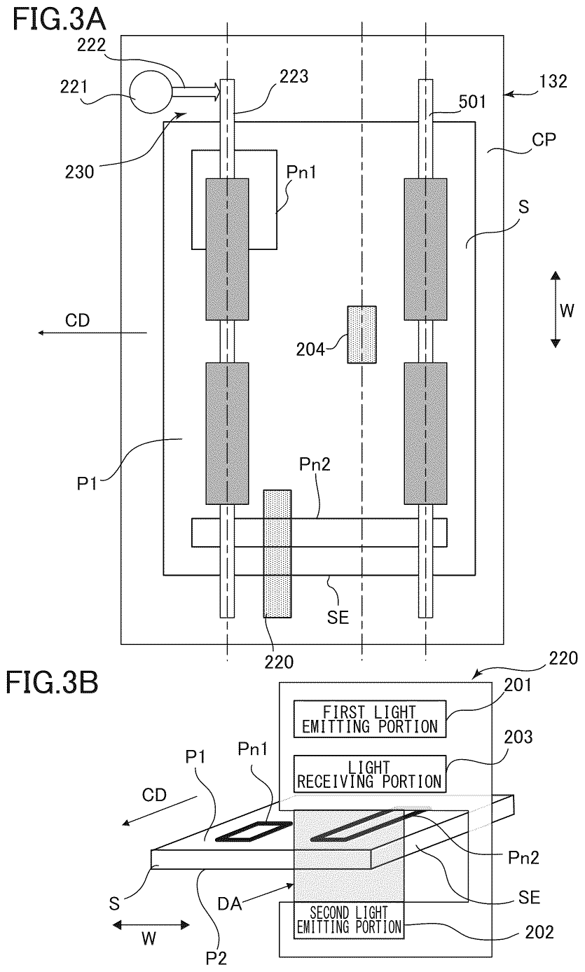

Next, using FIGS. 3A and 3B, a configuration of the registration unit 132 will be described. FIG. 3A is a plan view illustrating the registration unit 132, and FIG. 3B is a diagram illustrating an image sensor 220.

As illustrated in FIG. 3A, the registration unit 132 includes a conveyance roller 501, a sheet sensor 204, the image sensor 220, and a shift unit 230. The conveyance roller 501 conveys the sheet S in a sheet conveyance direction CD. The sheet sensor 204 is arranged downstream of the conveyance roller 501 in the sheet conveyance direction CD, and detects a position or the presence/absence of the sheet in a conveyance path CP on the registration unit 132.

As illustrated in FIG. 3B, the image sensor 220 includes a first light emitting portion 201, a second light emitting portion 202, and a light receiving portion 203. The first light emitting portion 201 is arranged to face the first surface P1 of the sheet S which is conveyed in the sheet conveyance direction CD in the conveyance path CP, and emits light toward the first surface P1. The second light emitting portion 202 is arranged to face the second surface P2 opposite to the first surface P1 of the sheet S which is conveyed in the sheet conveyance direction CD in the conveyance path CP, and emits light toward the second surface P2. To be noted, in one or more embodiments, the toner image is formed on the first surface P1 of the sheet S fed from the sheet feeding apparatus 20 at the secondary transfer portion 108.

The light receiving portion 203 is arranged to face the first surface P1 of the sheet S conveyed in the conveyance path CP. In addition, the light receiving portion 203 is capable of receiving both reflected light, which is emitted from the first light emitting portion 201 and reflected by the first surface P1, and transmitted light, which is emitted from the second light emitting portion 202 and passes through the second and first surfaces P2 and P1. In the sheet width direction W intersecting the sheet conveyance direction CD, these first and second light emitting portions 201 and 202 and light receiving portion 203 are arranged at positions corresponding to a side edge portion SE of the sheet S conveyed in the conveyance path CP.

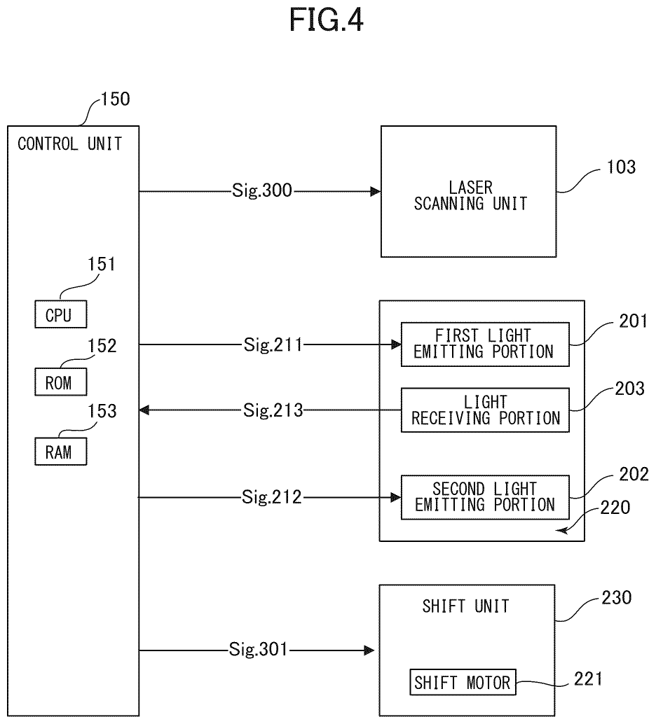

The reflected light and transmitted light described above pass through positions adjacent to the side edge portion SE of the sheet S, and a region in which the light receiving portion 203 may receive the reflected light and the transmitted light constitutes a detection region DA of the image sensor 220. The detection region DA possesses a predetermined width in the sheet width direction W. Based on the light receiving portion 203 receiving the reflected light described above as first light, a control unit 150 described below (refer to FIG. 4) detects a position of a pre-printed image, serving as a predetermined image which has been previously formed on the first surface P1 of the sheet S. In addition, based on the light receiving portion 203 receiving the transmitted light described above, the control unit 150 detects a position in the sheet width direction W of the side edge portion SE of the sheet S. In other words, based on the light receiving portion 203 receiving the aforementioned transmitted light, which serves as second light that has passed through the conveyance path CP, the control unit 150 detects the position in the sheet width direction W of the side edge portion SE of the sheet S.

For example, in an example illustrated in FIGS. 3A and 3B, pre-printed images Pn1 and Pn2 have been previously formed on the first surface P1 of the sheet S. In the sheet width direction W, the pre-printed image Pn1 is positioned at a position adjacent to a side edge portion of the sheet S on a side opposite to the image sensor 220. In the sheet width direction W, the pre-printed image Pn2 is positioned at a position adjacent to the side edge portion SE of the sheet S on a side of the image sensor 220. In addition, the pre-printed image Pn2 of the properly conveyed sheet S passes through the detection region DA of the image sensor 220. Therefore, the control unit 150 may detect the position of the pre-printed image Pn2 using the image sensor 220.

To be noted, in one or more embodiments, the light receiving portion 203 includes a plurality of light receiving pixels based on a predetermined resolution, and these plurality of light receiving elements are aligned in the sheet width direction W. For example, the light receiving portion 203 is constituted from a contact image sensor (CIS), but may be constituted from other sensors such as, for example, a charge coupled device (CCD).

The shift unit 230 includes a drive motor 221, a drive transmission mechanism 222, and a shift roller 223. The drive of the drive motor 221 is transmitted to the shift roller 223 through the drive transmission mechanism 222 constituted from a gear and the like, and, by this drive, the shift roller 223 may move in the sheet width direction W. That is, by moving the shift roller 223, which is in a state of nipping the sheet S, in the sheet width direction W, the shift unit 230 may move the sheet S in the sheet width direction W.

### Control Block for One or More Embodiments

FIG. 4 is a block diagram illustrating a control block of the image forming apparatus 10. As illustrated in FIG. 4, the image forming apparatus 10 includes the control unit 150. The control unit 150 includes a central processing unit (CPU) 151, a read only memory (ROM) 152, and a random access memory (RAM) 153. The CPU 151 executes various programs stored in the ROM 152. The RAM 153 is used as a working area for the CPU 151.

The laser scanning unit 103, the image sensor 220, and the shift unit 230 are connected to the control unit 150. As described above, the image sensor 220 includes the first and second light emitting portions 201 and 202 and the light receiving portion 203.

Based on a control signal Sig. 211 from the control unit 150, the first light emitting portion 201 emits light onto the first surface P1 of the sheet S in the conveyance path CP. In addition, based on a control signal Sig. 212 from the control unit 150, the second light emitting portion 202 emits light onto the second surface P2 of the sheet S in the conveyance path CP. To be noted, with respect to the sheet S which has passed through the duplex conveyance units 112 and 113 and has undergone reversed conveyance, the first light emitting portion 201 emits the light to the second surface P2 of the sheet S, and the second light emitting portion 202 emits the light to the first surface P1 of the sheet S.

In the detection region DA, the light receiving portion 203 may receive both the reflected light of the first light emitting portion 201 and the transmitted light of the second light emitting portion 202. An output signal Sig. 213 output from the light receiving portion 203 includes light receiving quantity information for each light receiving element included in the light receiving portion 203. Based on the output signal Sig. 213 from the light receiving portion 203, which is obtained by turning on the first and second light emitting portions at different timings, the control unit 150 detects the position of the side edge portion SE of the sheet S and the position of the pre-printed image (e.g., Pn2).

In addition, the control unit 150 performs the light quantity control of the light source in the laser scanning unit 103 based on a control signal Sig. 300, which includes the light source control data L1 to Ln generated from the user image formation data. At this time, based on the positional information of the side edge portion SE of the sheet S and the positional information of the pre-printed image, which have been obtained by the image sensor 220, by varying the light source control data, the control unit 150 may adjust a position of the electrostatic latent image formed on the photosensitive drum 101.

Further, by driving the drive motor 221 of the shift unit 230 based on a control signal Sig. 301 from the control unit 150, it is possible to move the sheet S, which is nipped by the shift roller 223, in the sheet width direction W. Based on the positional information of the side edge portion SE of the sheet S and the positional information of the pre-printed image, which have been obtained by the image sensor 220, the control unit 150 may adjust a movement amount by the shift unit 230 in the sheet width direction W of the sheet S.

### Image Position Alignment Control for One or More Embodiments

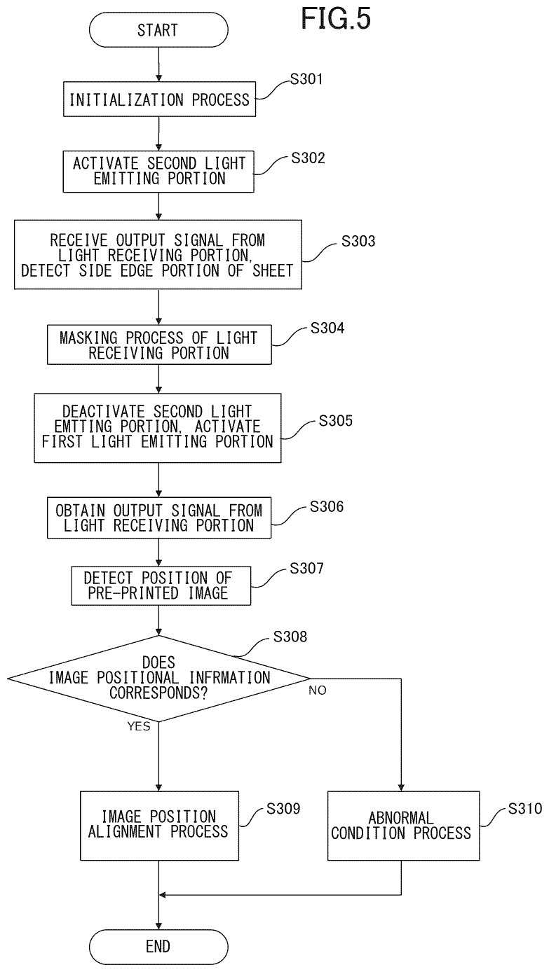

Next, using FIG. 5, image position alignment control in one or more embodiments will be described. FIG. 5 is a flowchart illustrating the image position alignment control, and the image position alignment control is performed by the control unit 150.

To be noted, the position of the pre-printed image on the sheet S, which is conveyed, and a formation position of the user image, which is formed in alignment with the pre-printed image, have been stored in the ROM 152 or the RAM 153 of the control unit 150 in advance. The position of the pre-printed image and the formation position of the user image may be stored in the control unit 150 through user operations such as, for example, reading of the pre-printed image and the acquisition of pre-printed image data.

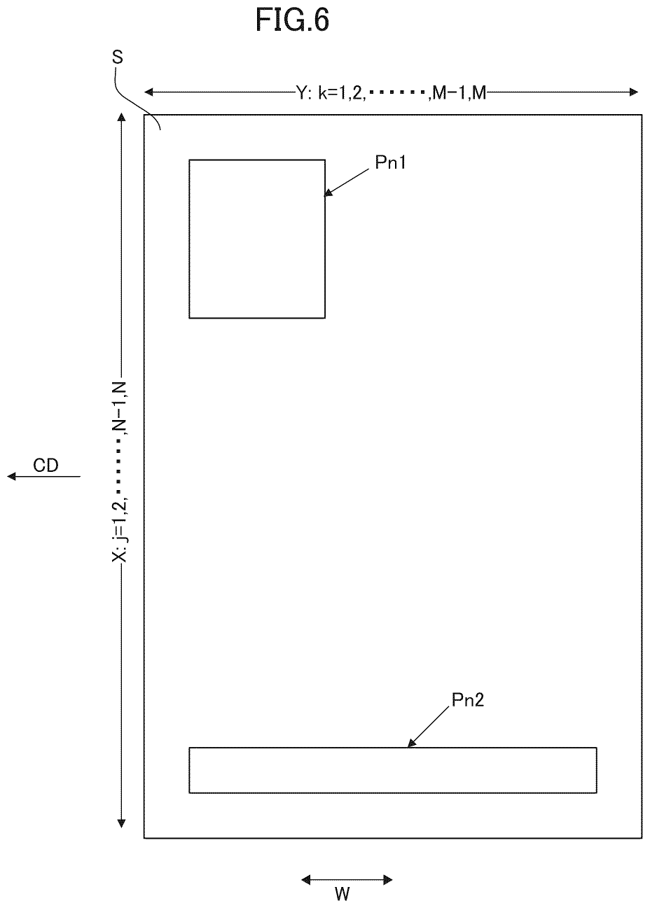

FIG. 6 is a diagram illustrating specific examples of the pre-printed images Pn1 and Pn2 which have been formed on the sheet S. As illustrated in FIG. 6, the two pre-printed images Pn1 and Pn2 have been previously formed on the first surface P1 of the sheet S. Image data of the pre-printed images Pn1 and Pn2 are stored in the RAM 153 of the control unit 150 as pixel-level luminance values based on a predetermined resolution, for each type of the sheet on which the pre-printed images have been formed. In one or more embodiments, a format of the pre-print image data on the sheet S is such that a pixel number on a long side (X side) of the sheet S is denoted by j, and a pixel number on a short side (Y side) is denoted by k, with each light quantity value (luminance value) received by individual light receiving element of the light receiving portion 203 corresponding to the pixel number represented as a value ranging from 0 to 255.

The light quantity values become darker and approach black as the values decrease, and become brighter and approach white as the values increase. An example of the image data of the pre-printed image is indicated in Table 1 below.

TABLE 1

| j: PIXEL NO. | k: PIXEL NO. | LUMINANCE VALUE |
|---|---|---|
| ON X SIDE | ON Y SIDE | OF PIXEL |
| 1 | 1 | 35 |
| 1 | 2 | 245 |
| . | . | . |
| . | . | . |
| . | . | . |
| N | M | 67 |

In Table 1, the pixel numbers along the long side (X side) of the sheet S range values from 1 to N, and the pixel numbers along the short side (Y side) of the sheet S range values from 1 to M. To be noted, N and M each represent natural numbers.

As illustrated in FIG. 5, when starting the image position alignment control, the control unit 150 first executes an initialization process (STEP S301). In this initialization process, the control unit 150 turns off the first and second light emitting portions 201 and 202 by the control signals Sig. 211 and Sig. 212, and executes an initial configuration with respect to the light receiving portion 203 to output detection data corresponding to a light receiving quantity.

Next, the control unit 150 turns on the second light emitting portion 202 in accordance with a conveyance state of the sheet S (STEP S302). For example, the control unit 150 turns on the light emitting portion 202 in response to the sheet sensor 204 detecting a leading edge of the sheet S, which is conveyed in the conveyance path CP. Thereby, the light emitted from the light emitting portion 202 transmits through the second and first surfaces P2 and P1 at a position adjacent to the side edge portion SE of the sheet S, which is conveyed.

The transmitted light that has transmitted through the second and first surfaces P2 and P1 is received at the light receiving portion 203, and the control unit 150 obtains the output signal Sig. 213 output from the light receiving portion 203 (STEP S303). Thereby, the control unit 150 may detect the position of the side edge portion SE of the sheet S based on the output signal Sig. 213. For example, the position of the side edge portion SE of the sheet S may be calculated by analyzing light quantities of a plurality of light receiving elements aligned in the sheet width direction W within the light receiving portion 203. This is because the light quantity of the light that has transmitted through the sheet Sis attenuated to a greater extent than that of the light that has not transmitted through the sheet S.

Next, the control unit 150 executes a masking process to disregard the light received by the light receiving portion 203 at locations further outward in the sheet width direction W than the detected position of the side edge portion SE of the sheet S. That is, among the plurality of light receiving elements of the light receiving portion 203, light receiving data of the light receiving elements which are subjected to the masking process are disabled.

Next, the control unit 150 turns off the second light emitting portion 202, and, thereafter, turns on the first light emitting portion 201 (STEP S305). Thereby, the light emitted from the first light emitting portion 201 is reflected by the first surface P1 at a position adjacent to the side edge portion SE of the sheet S which is conveyed. This reflected light is received by the light receiving portion 203, and the control unit 150 obtains the output signal Sig. 213 output from the light receiving portion 203 (STEP S306).

Then, based on the output signal Sig. 213, the control unit 150 may detect the position of the pre-printed image formed on the first surface P1 at a position adjacent to the side edge portion SE of the sheet S (STEP S307). For example, the position of the pre-printed image may be calculated by analyzing a contrast in light quantities received by a plurality of light receiving elements disposed within the light receiving portion 203, which are aligned in the sheet width direction W. This is because the contrast in the light quantity of the reflected light is generated between a portion of the sheet S on which the image is not formed (for example, white surface) and a portion of the sheet on which the pre-printed image of the sheet S is formed (for example, black surface).

Next, the control unit 150 determines whether or not the positional information of the pre-printed image detected at STEP S307 matches the positional information of the pre-printed image stored in the RAM 153 in advance (STEP S308). In a case where it is determined that the positional information of the pre-printed image detected at STEP S307 does not match the positional information of the pre-printed image stored in the RAM 153 in advance (STEP S308: NO), the control unit 150 executes an abnormal condition process (STEP S310).

As the abnormal condition process, examples include a sheet discharge process that discharges the relevant sheet S subject to STEPS S301 to S308 to an escape tray, not shown, disposed in the image forming apparatus 10, or a jam handling process that treats the relevant sheet S as a jammed sheet and stops the image forming apparatus 10. For example, the image forming apparatus 10 includes the sheet discharge tray 120, serving as a first tray, and the escape tray, not shown, serving as a second tray which is different from the sheet discharge tray 120. Then, in the case where it is determined that the positional information of the pre-printed image detected at STEP S307 does not match the positional information of the pre-printed image stored in the RAM 153 in advance (STEP S308: NO), as an example of the abnormal condition process (STEP S310), the sheet discharge conveyance unit 110 discharges the sheet to the escape tray in the sheet discharge process. To be noted, in the jam handling processes and the sheet discharge process, the subject sheet S is not counted as a properly printed sheet. These abnormal condition processes may be configured by the user in advance, and are not limited to the examples described above.

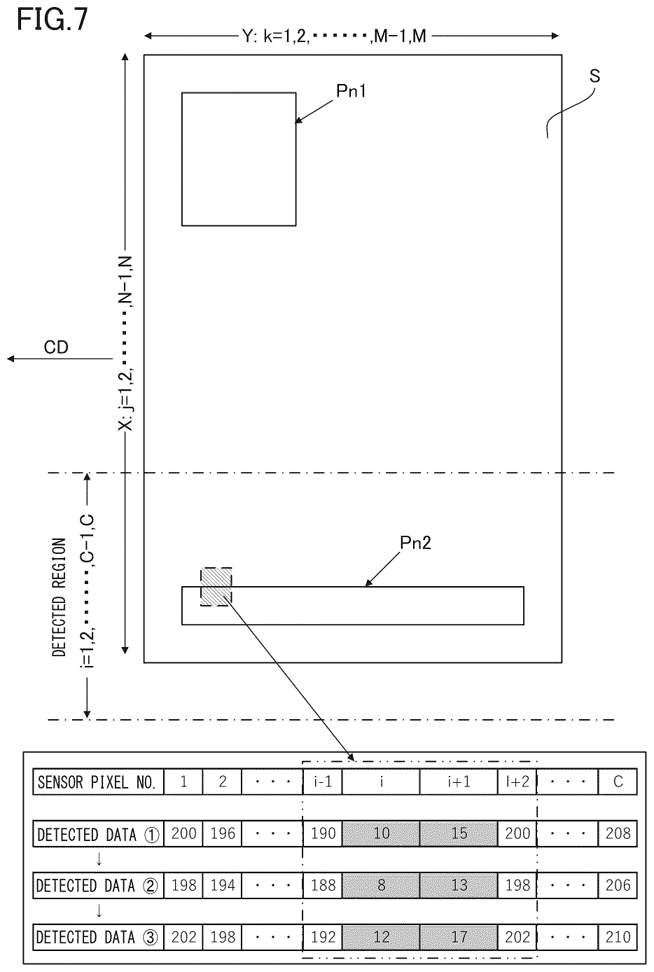

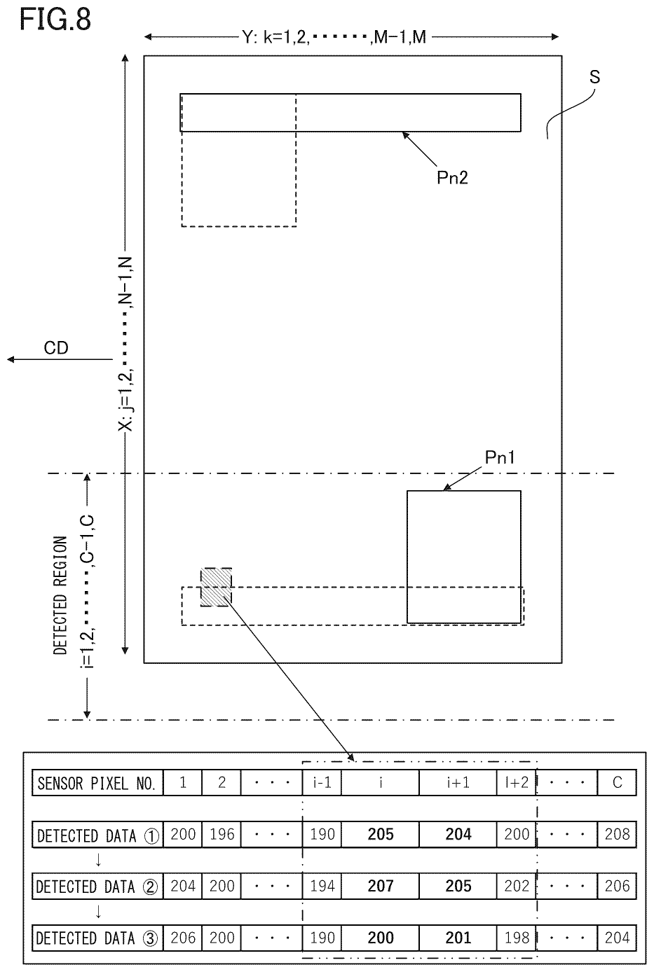

Using FIGS. 7 and 8, an example will be described where the positional information of the pre-printed image detected at STEP S307 does not match the positional information of the pre-printed image stored in the RAM 153 in advance. As illustrated in FIG. 7, i represents the light receiving pixel number in the detection area DA of the image sensor 220, and C represents the number of light receiving pixels. To be noted, i is a natural number ranging from 1 to C, and the number of light receiving pixels C is defined as “black” in a case where C is equal to or less than 20, and as “white” in a case where C is equal to or more than 180.

Upper sections of FIGS. 7 and 8 illustrate the sheet S conveyed in the conveyance path CP, and FIGS. 7 and 8 respectively illustrate a case where the sheet S which is set in a correct orientation is conveyed and a case where the sheet S which is set in an incorrect orientation is conveyed. The orientation of the sheet S illustrated in FIG. 8 corresponds to the orientation of the sheet S illustrated in FIG. 7 after a 180 degree rotation. Lower sections of FIGS. 7 and 8 illustrate the image data that the image sensor 220 sequentially outputs in conjunction with the conveyance of the sheet S within a portion (hatched area in the figures) of the detection area DA of the image sensor 220.

As illustrated in FIG. 7, in the case where the sheet S is set in the orientation (correct orientation) preset in the control unit 150, the image sensor 220 detects the pre-printed image Pn2 as a “black” line image at locations of pixel numbers i and i+1. On the other hand, as illustrated in FIG. 8, in the case where the sheet S is set in the orientation (incorrect orientation) which is different from the orientation preset in the control unit 150, the image sensor 220 detects a “white” line image at the locations of the pixel numbers i and i+1. That is, in this case, the control unit 150 determines that the pre-printed image is absent at the locations of the pixel numbers i and i+1, and the positional information of the pre-printed image which is detected does not match the positional information of the pre-printed image stored in the RAM 153 in advance.

As described above, examples in which the positional information of the pre-printed image detected at STEP S307 does not match the positional information of the pre-printed image stored in the RAM 153 in advance include, for, example, the case where the orientation for setting the sheet S is incorrect. In addition, other examples include a case where the sheet S with no pre-printed image formed is conveyed, or a case where the pre-printed image on the sheet S has image formation defects (such as registration errors or insufficient image density).

Returning to the flowchart in FIG. 5, in a case where it is determined that the positional information of the pre-printed image detected at STEP S307 corresponds to the positional information stored in the RAM 153 in advance (STEP S308: YES), the control unit 150 executes an image position alignment process (STEP S309). In one or more embodiments, as the image position alignment process, the sheet S is moved in the sheet width direction W by the shift unit 230. The control unit 150 calculates a moving amount (shift amount) of the sheet S by the shift unit 230 from the position of the side edge portion SE of the sheet S detected at STEP S303 and the position of the pre-printed image detected at STEP S307.

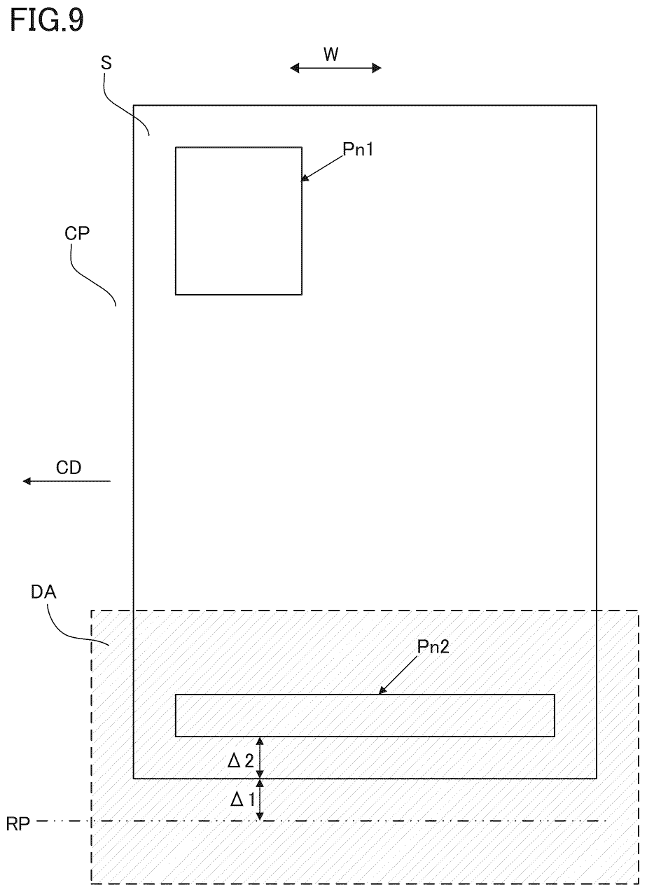

FIG. 9 is a diagram illustrating an example of a method for calculating the shift amount of the sheet S.

As illustrated in FIG. 9, the control unit 150 stores a predetermined reference position in the sheet width direction W in the conveyance path CP. In FIG. 9, this reference position will be described as a reference line RP extending in the sheet conveyance direction CD. The control unit 150 calculates a distance A1 in the sheet width direction W between the position of the side edge portion SE of the sheet S detected at STEP S303 and the reference line RP. In addition, the control unit 150 calculates a distance A2 between the position of the side edge portion SE of the sheet S detected at STEP S303 and the position of the pre-printed image detected at STEP S307. That is, based on the detection results of the reflected light and the transmitted light described above, which have been detected by the light receiving portion 203, the control unit 150 detects the position in the sheet width direction W of the pre-printed image with respect to the side edge portion SE of the sheet S.

To be noted, for example, in a case where the sum of the distances A1 and A2 is equal to or larger than a predetermined threshold, the control unit 150 determines at STEP S308 that the positional information of the pre-printed image detected at STEP S307 does not match the positional information of the pre-printed image stored in the RAM 153 in advance.

In other words, in a case where the sum of the distances A1 and A2 is less than the predetermined threshold, by executing the image position alignment process at STEP S309, the control unit 150 aligns the position of the pre-printed image and the position of the user image formed at the secondary transfer portion 108.

In one or more embodiments, at STEP S309, the control unit 150 calculates the moving amount of the sheet S in the sheet width direction W based on the distances A1 and A2 described above, and controls the drive motor 221 of the shift unit 230 based on this moving amount. In other words, based on the detected position of the side edge portion SE of the sheet S and the position of the pre-printed image Pn2 on the first surface P1, the control unit controls the shift unit 230 so as to adjust a relative position between the pre-printed image Pn2 on the first surface P1 and the user image to be formed on the sheet S by the image forming unit 30.

Thereby, the pre-printed image and the user image formed at the secondary transfer portion 108 are aligned, and it is possible to obtain high quality deliverables. Thereby, the image position alignment control illustrated in FIG. 5 ends.

As described above, in one or more embodiments, using the image sensor 220, it is possible to detect both the position of the side edge portion SE of the sheet S and the position of the pre-printed image Pn2, serving as the predetermined image previously formed on the sheet S. Therefore, even if both the position of the side edge portion SE and the position of the pre-printed image Pn2 deviate from their nominal positions, it is possible to accurately form the user image on the sheet S at the secondary transfer portion 108 in alignment with the position of the pre-printed image Pn2.

In addition, the image sensor 220 includes the first and second light emitting portions 201 and 202 and the light receiving portion 203, and the light receiving portion 203 receives both the transmitted light of the second light emitting portion 202 and the reflected light of the first light emitting portion 201. Therefore, by using only one light receiving portion with respect to the two light emitting portions, it is possible to detect both the position of the side edge portion SE of the sheet S and the position of the pre-printed image Pn2; thereby, it is possible to achieve cost reduction.

Further, with respect to a single predetermined sheet S, which becomes a target for detection, the control unit 150 turns on the first light emitting portion 201 after turning off the second light emitting portion 202. As a result, the transmitted light of the second light emitting portion 202 and the reflected light of the first light emitting portion 201 do not overlap; thereby, it is possible to improve the detection accuracy of the position of the side edge portion SE and the position of the pre-printed image Pn2.

### Variant Example 1 of One or More Embodiments

To be noted, in one or more embodiments described above, in the image position alignment process at STEP S309 of FIG. 5, the sheet S is moved in the sheet width direction W by the shift unit 230; however, it is not limited to this. For example, the control unit 150 may control the position in the sheet width direction of the user image formed on the sheet S at the secondary transfer portion 108.

In more particular, the control unit 150 outputs the control signal Sig. 300 including the light source control data to the laser scanning unit 103 based on the distances A1 and A2 described above. Thereby, the laser scanning unit 103 adjusts a position in the sheet width direction W of the electrostatic image formed on the photosensitive drum 101 in alignment with the position of the pre-printed image Pn2 on the sheet S. In other words, based on the detected positions of the side edge portion SE of the sheet S and the pre-printed image Pn2 on the first surface P1, the control unit 150 controls the position in the sheet width direction W of the user image formed on the sheet S at the image formation position so as to adjust the relative position between the pre-printed image Pn2 on the first surface P1 and the user image formed on the sheet S by the image forming unit 30. Thereby, the positions of the pre-printed image and the user image formed at the secondary transfer portion 108 are aligned, and it is possible to obtain high quality deliverables.

To be noted, in this variant example 1, the configuration of the shift unit 230 may be omitted.

### Variant Example 2 of One or More Embodiments

In addition, in the image position alignment process at STEP S309, the control unit 150 may execute both the process of the one or more embodiments described above and the process of the variant example 1 described above in combination. That is, the image position alignment process may include both the process of moving the sheet S in the sheet width direction W by the shift unit 230 and the process of adjusting the position of the electrostatic latent image by the laser scanning unit 103.

### One or More Additional Embodiments

While, next, one or more additional embodiments of the present disclosure will be described. One or more additional embodiments may be configured such that an image position alignment process corresponding to STEP S309 described above is configured to be executed in an image forming apparatus of an inkjet system. Therefore, illustrations of configurations similar to those of the aforementioned one or more embodiments will be omitted, or will be described by putting the same reference characters on drawings.

### Schematic Configuration of Inkjet Recording Apparatus for One or More Additional Embodiments

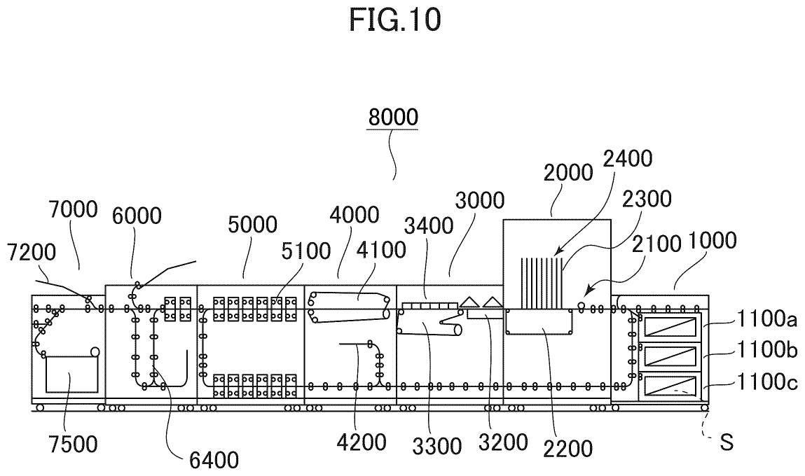

FIG. 10 is a schematic diagram illustrating an example of a schematic configuration of an inkjet recording apparatus 8000, serving as an image forming apparatus according to one or more additional embodiments. This inkjet recording apparatus 8000 is a sheet-fed inkjet recording apparatus that produces recorded matter by forming an inkjet image on the sheet S using a two-liquid system of a reaction liquid and ink. As the sheet S, serving as a recording material (recording medium), various sheet materials of different sizes and materials, including paper such as plain paper and thick paper, surface treated sheet materials such as coated paper, sheet materials of special shapes such as envelopes and index paper, plastic films, cloth, and the like may be utilized.

As illustrated in FIG. 10, the inkjet recording apparatus 8000 of one or more additional embodiments includes a sheet feed module 1000, a print module 2000, a drying module 3000, a fixing module 4000, and a cooling module 5000. In addition, the inkjet recording apparatus 8000 of one or more additional embodiments includes a reverse module 6000 and a stacking module 7000. The sheet S, which is a cut-sheet, supplied from the sheet feed module 1000 is conveyed along a conveyance path, processed at each module, and stacked in the stacking module 7000.

The sheet feed module 1000 includes three storage compartments 1100a, 1100b, and 1100c, each storing the sheet S. Each of the storage compartments 1100a to 1100c may be withdrawn toward an apparatus front side with respect to a casing of the sheet feed module 1000. The sheet feed module 1000 feeds the sheet S stored in each of the storage compartments 1100a to 1100c one sheet at a time using a separation belt and a conveyance roller, and conveys it to the print module 2000. To be noted, the number of storage compartments 1100a to 1100c is not limited to three, and may be one or two, or equal to or more than four.

The print module 2000 includes a registration unit 2100, a print belt unit 2200, a recording unit 2300, and the like. The positional deviation of the sheet S conveyed from the sheet feed module 1000 is corrected by the registration unit 2100, and, thereafter, the sheet S is conveyed to the print belt unit 2200. The recording unit 2300 is arranged at a position that faces the print belt unit 2200 across the conveyance path.

In one or more additional embodiments, the term “positional deviation” of the sheet S includes both positional deviation in the sheet width direction of the sheet S (hereinafter, referred to as “lateral deviation”) and positional deviation in a rotational direction of the sheet S when viewed in a thickness direction of the sheet S (hereinafter, referred to as “skew”). Correcting the skew of the sheet S is referred to as skew correction. Aligning the sheet S to a desired position in the sheet width direction W by correcting the lateral deviation is referred to as lateral registration.

The registration unit 2100 of one or more additional embodiments performs a correction operation that simultaneously corrects both the skew and the lateral deviation of the sheet S. This correction operation may be performed in a plurality of steps for each individual sheet S. To be noted, registration unit 2100 may correct only one of the skew and the lateral deviation of the sheet S. In addition, the registration unit 2100 includes a configuration similar to the registration unit 132 described in the aforementioned one or more embodiments, and its description will be omitted.

The recording unit 2300 is an image forming unit that forms the image by performing a recording process (imprinting, printing) with respect to the sheet S, which is conveyed, using recording heads 2400 from above. By conveying the sheet S in a state of being attracted by the print belt unit 2200, clearance between the recording heads 2400 and the sheet S is secured. In addition, the recording heads 2400 are arranged in a plurality along the sheet conveyance direction. In one or more additional embodiments, the recording unit 2300 includes five line type recording heads that correspond to four colors, i.e., yellow (Y), magenta (M), cyan (C), and black (K), and the reaction liquid.

To be noted, the number of colors and recording heads is not limited to five. The inkjet system may adopt configurations based on thermal heating elements, piezoelectric elements, electrostatic elements, or micro electromechanical system (MEMS) elements, and the like. The ink of each color is supplied from ink tanks to the recording heads 2400 via each ink tube. The sheet S on which the image has been formed by the recording unit 2300 is conveyed by the print belt unit 2200, and an inline scanner arranged downstream of the recording unit 2300 in the sheet conveyance direction detects misalignment and color density of the image formed on the sheet S; thereby, the correction of the printed image is enabled.

The drying module 3000 includes a decoupling unit 3200, a drying belt unit 3300, and a warm air blowing unit 3400. The drying module 3000 is a unit that reduces liquid contents in the ink applied onto the sheet S by the recording unit 2300 and, thereby, enhances fixability between the sheet S and the ink. The sheet S on which the image has been formed by the recording unit 2300 of the print module 2000 is conveyed to the decoupling unit 3200 arranged within the drying module 3000. In the decoupling unit 3200, the sheet S may be conveyed by means of wind pressure from above and belt friction, and, by weakly holding and conveying the sheet S on the belt, the positional deviation of the sheet S on the print belt 2200 that forms an ink image is prevented. The sheet S conveyed from the decoupling unit 3200 is conveyed by suction via the drying belt unit 3300, and, at the same time, by receiving hot air from the warm air blowing unit 3400 arranged above the belt, the drying of the ink applied surface is performed. To be noted, in addition to the hot air drying method, it is also acceptable to combine methods such as irradiating the surface of the sheet S with electromagnetic waves (e.g., ultraviolet or infrared radiation) or utilizing a conductive heat transfer method through contact with a heating element.

The fixing module 4000 includes a fixing belt unit 4100 provided with an upper belt unit and a lower belt unit. The fixing module 4000 may fix the ink on the sheet S by passing the sheet S conveyed from the drying module 3000 through a gap between the heated upper and lower belt units.

The cooling module 5000 includes a plurality of cooling units 5100, and cools the high temperature sheet S conveyed from the fixing module 4000. The cooling unit 5100 draws outside air into a cooling box via a fan to increase pressure within the cooling box, and cools the sheet S by directing airflow ejected from nozzles formed in a conveyance guide onto the sheet S. The cooling units 5100 are arranged on both sides with respect to the conveyance path, and may cool the sheet S from both surfaces. In addition, a conveyance path switch portion is disposed within the cooling module 5000. The conveyance path switch portion switches the conveyance path of the sheet S between a path for conveying the sheet S to the reverse module 6000, and a duplex conveyance path which is used during duplex printing. During the duplex printing, the sheet S having the image formed on its first surface is conveyed to a conveyance path below the cooling module 5000, and is conveyed through each of duplex conveyance paths of the fixing, drying, print, and sheet feed modules 4000, 3000, 2000, and 1000. Then, the sheet S is again conveyed to the registration unit 2100, the print belt unit 2200, and the recording unit 2300 of the print module 2000, and the image is formed on the second surface opposite to the first surface at the recording unit 2300.

In a duplex conveyance unit of the fixing module 4000, a first reverse unit 4200 that inverts front and back sides of the sheet S is disposed. In addition, the reverse module 6000 includes a second reverse unit 6400, and may invert the front and back sides of the sheet S which is conveyed; thereby, it is possible to freely change the front and back orientations of the sheet S which is discharged. The stacking module 7000 includes a top tray 7200 and a stacking portion 7500, and stacks the sheets S conveyed from the reverse module 6000 while aligning them.

### Control Block for One or More Additional Embodiments

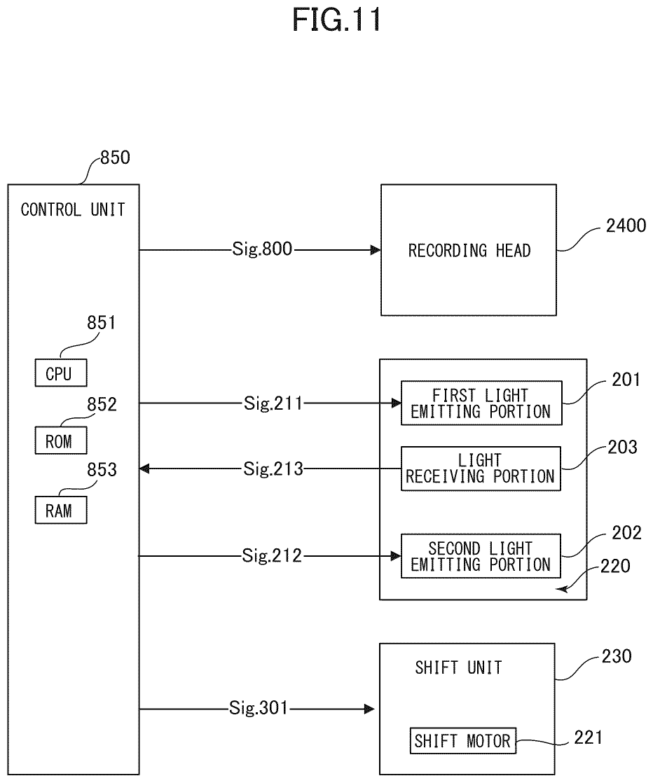

FIG. 11 is a block diagram illustrating a control block of the inkjet recording apparatus 8000. The inkjet recording apparatus 8000 includes a control unit 850. The control unit 850 includes a central processing unit (CPU) 851, a read only memory (ROM) 852, and a random access memory (RAM) 853. The CPU 851 executes various programs stored in the ROM 852. The RAM 853 is used as a working area for the CPU 851.

The recording heads 2400, the image sensor 220, and the shift unit 230 are connected to the control unit 850. Configurations of the image sensor 220 and the shift unit 230 are identical to the aforementioned one or more embodiments.

In addition, the control unit 850 performs the control of ink ejection amounts of the recording heads 2400 based on a control signal Sig. 800 including ink ejection amount control data generated from the user image formation data. At this time, based on the positional information of the side edge portion SE of the sheet S and the positional information of the pre-printed image, which are obtained by the image sensor 220, by varying the ink ejection amount control data, the control unit 850 may adjust a formation position of the ink image formed on the sheet S.

Then, also in one or more additional embodiments, the control unit 850 performs the image position alignment control illustrated in FIG. 5. At this time, at STEP S309 of the image position alignment process, similar to the aforementioned one or more embodiments, the control unit 850 may perform the process of moving the sheet S in the sheet width direction W using the shift unit 230. In addition, by controlling the recording heads 2400, the control unit 850 may perform a process of adjusting the formation position of the ink image formed on the sheet S. In addition, these processes may be executed in combination.

As described above, even in the inkjet recording apparatus 8000 as in one or more additional embodiments, using the image sensor 220, it is possible to detect both the position of the side edge portion SE of the sheet S and the position of the pre-printed image Pn2, serving as the predetermined image previously formed on the sheet S. Therefore, even if both the position of the side edge portion SE and the position of the pre-printed image Pn2 deviate from their nominal positions, it is possible to accurately form the user image on the sheet S by the recording unit 2300 in alignment with the position of the pre-printed image Pn2.

### Other Embodiments

To be noted, the registration unit 132 may correct the skew of the sheet S in the aforementioned one or more embodiments. For example, the skew of the sheet S may be corrected by aligning the leading edge of the sheet S with a nip of the shift roller 230 of the registration unit 132. In addition, by disposing a shutter member, against which the leading edge of the sheet S abuts, in the registration unit 132, it is acceptable to correct the skew of the sheet S by abutting the leading edge of the sheet S against this shutter member.

In addition, in the variant example 1 of the one or more embodiments, in a case where the sheet detected by the image sensor 220 is referred to as a first sheet, it is acceptable to perform the image position alignment process with respect to a second sheet succeeding the first sheet using detection results with respect to the first sheet. For example, in a case where a predetermined time is used for conveying the toner image formed on the photosensitive drum 101 to the secondary transfer portion 108 via the intermediate transfer belt 107, it is possible to enhance throughput by performing the aforementioned control.

According to the present disclosure, it is possible to detect both the position of the side edge portion of the sheet and the position of the predetermined image previously formed on the sheet.

Embodiment(s) of the present disclosure may also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims priority to, and the benefit of, Japanese Patent Application No. 2025-017427, filed Feb. 5, 2025, which is hereby incorporated by reference herein in its entirety.

What is claimed is:

1. An image forming apparatus comprising:
a first light emitting portion disposed to face a first surface of a sheet conveyed in a conveyance path in a sheet conveyance direction, the first light emitting portion being configured to emit light toward the first surface;
a second light emitting portion disposed to face a second surface opposite to the first surface of the sheet conveyed in the conveyance path, the second light emitting portion being configured to emit light toward the second surface;
a light receiving portion disposed to face the first surface of the sheet conveyed in the conveyance path, the light receiving portion being configured to receive a first light that is emitted from the first light emitting portion and is reflected by the first surface, and to receive a second light that is emitted from the second light emitting portion and is passed through the conveyance path; and
one or more processors that operate to:
(i) detect a position of a side edge portion of the sheet in a sheet width direction intersecting the sheet conveyance direction based on the light receiving portion receiving the second light, and
(ii) detect a position of a predetermined image previously formed on the first surface of the sheet based on the light receiving portion receiving the first light.

2. The image forming apparatus according to claim 1, wherein the one or more processors further operate to detect the position of the predetermined image in the sheet width direction with respect to the position of the side edge portion of the sheet based on a detection result of the second light received by the light receiving portion and a detection result of the first light received by the light receiving portion.

3. The image forming apparatus according to claim 1, wherein the one or more processors further operate to:
turn on the second light emitting portion with respect to a predetermined sheet;
turn off the second light emitting portion; and
after the second light emitting portion is turned off, turn on the first light emitting portion with respect to the predetermined sheet.

4. The image forming apparatus according to claim 1, wherein, in the sheet width direction intersecting the sheet conveyance direction, the first light emitting portion, the second light emitting portion, and the light receiving portion are disposed at positions that correspond to the side edge portion of the sheet conveyed in the conveyance path.

5. The image forming apparatus according to claim 1, further comprising:
a shifter disposed downstream of the first light emitting portion, the second light emitting portion, and the light receiving portion in the sheet conveyance direction, the shifter being configured to move the sheet in the sheet width direction; and
an image forming structure configured to form an image on the sheet conveyed in the conveyance path at an image formation position which is located downstream of the shifter in the sheet conveyance direction,
wherein the one or more processors further operate to control the shifter so as to adjust a relative position between the predetermined image on the first surface and the image formed on the sheet by the image forming structure, based on a detected position of the side edge portion of the sheet and a detected position of the predetermined image on the first surface.

6. The image forming apparatus according to claim 1, further comprising an image forming structure configured to form an image on the sheet conveyed in the conveyance path at an image formation position which is located downstream of the light receiving portion in the sheet conveyance direction,
wherein the one or more processors further operate to control a position, in the sheet width direction, of the image at the image formation position so as to adjust a relative position between the predetermined image on the first surface and the image formed on the sheet by the image forming structure, based on the detected position of the side edge portion of the sheet and the detected position of the predetermined image on the first surface.

7. The image forming apparatus according to claim 6, wherein the image forming structure includes:
a photosensitive member;
an exposing structure or laser scanner configured to form an electrostatic latent image on the photosensitive member by irradiating light onto the photosensitive member; and
a developer configured to develop the electrostatic latent image on the photosensitive member as the image, and
wherein the one or more processors further operate to control the exposing structure or laser scanner so as to adjust the position of the electrostatic latent image in the sheet width direction, thereby controlling the position, in the sheet width direction, of the image formed on the sheet at the image formation position.

8. The image forming apparatus according to claim 6, wherein the image forming structure includes a recording head configured to form the image by ejecting ink, and
wherein the one or more processors further operate to control the position, in the sheet width direction, of the image formed on the sheet at the image formation position by controlling the recording head.

9. The image forming apparatus according to claim 1, wherein the one or more processors further operate to perform a process of disregarding detection data relating to the first light that is emitted from the first light emitting portion and received by the light receiving portion at positions outside, in the sheet width direction, the detected position of the side edge portion of the sheet after the light receiving portion has received the second light emitted from the second light emitting portion.

10. The image forming apparatus according to claim 1, wherein the light receiving portion includes a plurality of light receiving elements aligned in the sheet width direction.

11. The image forming apparatus according to claim 1, further comprising:
a memory configured to store positional information of the predetermined image;
a first tray configured to stack the sheet;
a second tray configured to stack the sheet, the second tray being different from the first tray; and
a sheet discharge structure or conveyor configured to discharge the sheet to the first tray or the second tray,
wherein, in a case where positional information of the predetermined image previously formed on the first surface of a detected sheet matches the positional information of the predetermined image stored in the memory, the sheet discharge structure or conveyor is configured to discharge the sheet to the first tray, and
wherein, in a case where the positional information of the predetermined image previously formed on the first surface of the detected sheet does not match the positional information of the predetermined image stored in the memory, the sheet discharge structure or conveyor is configured to discharge the sheet to the second tray.

12. An image forming apparatus comprising:
a first light emitting portion disposed to face a first surface of a sheet conveyed in a conveyance path in a sheet conveyance direction, the first light emitting portion being configured to emit light toward the first surface;
a second light emitting portion disposed to face a second surface opposite to the first surface of the sheet conveyed in the conveyance path, the second light emitting portion being configured to emit light toward the second surface;
a light receiving portion disposed to face the first surface of the sheet conveyed in the conveyance path, the light receiving portion being configured to receive a first light that is emitted from the first light emitting portion and is reflected by the first surface, and to receive a second light that is emitted from the second light emitting portion and is passed through the conveyance path;
a shifter disposed downstream of the first light emitting portion, the second light emitting portion, and the light receiving portion in the sheet conveyance direction, the shifter being configured to move the sheet in a sheet width direction intersecting the sheet conveyance direction; and
one or more processors that operate to control the shifter based on a detection result of the first light received by the light receiving portion and a detection result of the second light received by the light receiving portion.
